(19) United States
(12) Patent Application Publication
(10) Pub. No.: US 2022/0122057 A1
(43) Pub. Date: Apr. 21, 2022

(54) A USER INTERACTION EVENT DETECTION AND PAYMENT PROCESSING SYSTEM

(71) Applicant: SOLOS LIMITED, Hunters Hill (AU)

(72) Inventor: George MONEMVASITIS, Hunters Hill (AU)

(21) Appl. No.: 17/432,431

(22) PCT Filed: Mar. 17, 2020
(86) PCT No.: PCT/AU2020/050252

§ 371 Date: Aug. 19, 2021

(30) Foreign Application Priority Data
Aug. 14, 2019 (AU) 2019902933

(51) Int. Cl. G06Q 20/32

(52) U.S. Cl. CPC G06Q 20/3278

(57) ABSTRACT

A system has a server, user electronic device associated with a user profile and merchandise comprising an embedded device comprising an NFC card emulator. A registration controller receives merchandise ID data scanned from the embedded device to associate the merchandise with the user profile. An event detection controller detects a user interaction events of the user electronic device specified by trigger data. A payment voucher issuer controller generates an electronic payment voucher according to a type of the user interaction event and a payment amount associated with the payment voucher. Payment voucher data is a written to at least one of the NFC card emulator of the merchandise and the user electronic device. As such, a POS terminal can read the payment voucher data to determine a primary account number for electronically processing a payment up to the value of the payment amount.

### FIELD OF THE INVENTION

This invention relates generally to a system which is configured for dynamically generating electronic payment vouchers when detecting various types of user interactions of users and their associated merchandise which may be used for contactless payment using conventional POS terminals.

### BACKGROUND OF THE INVENTION

Radio frequency identification (RFID) is the process by which items are uniquely identified using radio waves wherein a reader sends an interrogating signal to a tag via an antenna thereof, and the tag responds with unique information.

Near-field communication (NFC) is a specialized subset of RFID technology. Specifically, NFC is a branch of High-Frequency (HF) RFID, and both RFID and NFC operate at the 13.56 MHz frequency. NFC allows for secure data exchange in that an NFC device is capable of being both an NFC reader and an NFC tag, allowing for peer-to-peer communication.

This unique ability has made NFC a popular choice for contactless payment. NFC payment transactions between a mobile device and a POS terminal use the same ISO/IEC 14443 standard communication protocol used by EMV and U.S. contactless credit and debit cards, allowing the mobile device to emulate a contactless card.

This NFC card emulation enables NFC-enabled devices to act like smart cards, allowing users to perform transactions such as payment or ticketing.

### SUMMARY OF THE DISCLOSURE

There is provided herein a system which is configured for dynamically generating electronic payment vouchers when detecting various types of user interactions of users and their associated merchandise which may be used for contactless payment using conventional POS terminals.

Specifically, the present system comprises at least one user electronic device in operable communication with a server across a wide area network.

Furthermore, the system comprises merchandise comprising an embedded device which may comprise an RFID tag and/or NFC emulator.

The server comprises a registration controller configured to receive merchandise ID data scanned from the embedded device (typically the RFID tag) by the user electronic device to associate user profiles against various pieces of merchandise.

The server further comprises trigger data which is used by an event detection controller to detect different types of user interaction events, such as scanning of RFID tags, associating merchandise items, being within proximity of wireless beacons, within geo-fences and the like.

When detecting an event, the payment voucher issue controller is configured for generating a payment voucher according to the type of user interaction event and an associated payment amount.

Payment voucher data is written to the tag of the NFC card emulator of the merchandise and/or user electronic device which may then be used for contactless payment of the allocated amount.

Specifically, a POS terminal may read the payment voucher data from the NFC card emulator and a payment network may determine a primary account number therefrom for processing payment up to the value of the payment amount of the payment voucher.

The payment voucher data may comprise a tokenisation of the primary account number received from a token service provider wherein the payment network obtains the primary account number from the token service provider using the tokenisation when processing payment.

In alternative embodiments, the system may generate a one-time use virtual primary account according to the payment amount and generating a one-time use primary account number therefore.

In embodiments, the payment voucher data may be encrypted prior writing to the NFC card emulator. As such, in use, when processing payment, a payment controller of the user electronic device may intercept a payment request and transmit the encrypted payment voucher data to the server for decrypting and receive decrypted payment voucher data therefrom which is then transmitted to the POS terminal. The encrypted payment voucher data may be decrypted according to various payment voucher payment restriction data types such as merchant ID so that, for example, the payment voucher may only be redeemed for particular merchants or merchandise ID so that, for example, the payment voucher may be only redeemed for particular types of merchandise.

The payment vouchers may be generated with voucher payment restrictions, including those relating to merchant identifiers, types of merchandise and particular locations for restricting payment against issued vouchers accordingly.

In embodiments, the voucher issue controller may be configured for issuing electronic vouchers to a plurality of user electronic devices when the user electronic devices are detected as congregating at a particular location as may be determined using respective GPS receivers thereof or readers configured for determining proximity with a wireless proximity beacon.

In embodiment, the server may utilise a machine learning to generate trigger data which optimises user interaction therewith. In accordance with this embodiment, the machine learning may maximise the generation of events according to user profile types.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a user interaction event detection and payment processing system; and

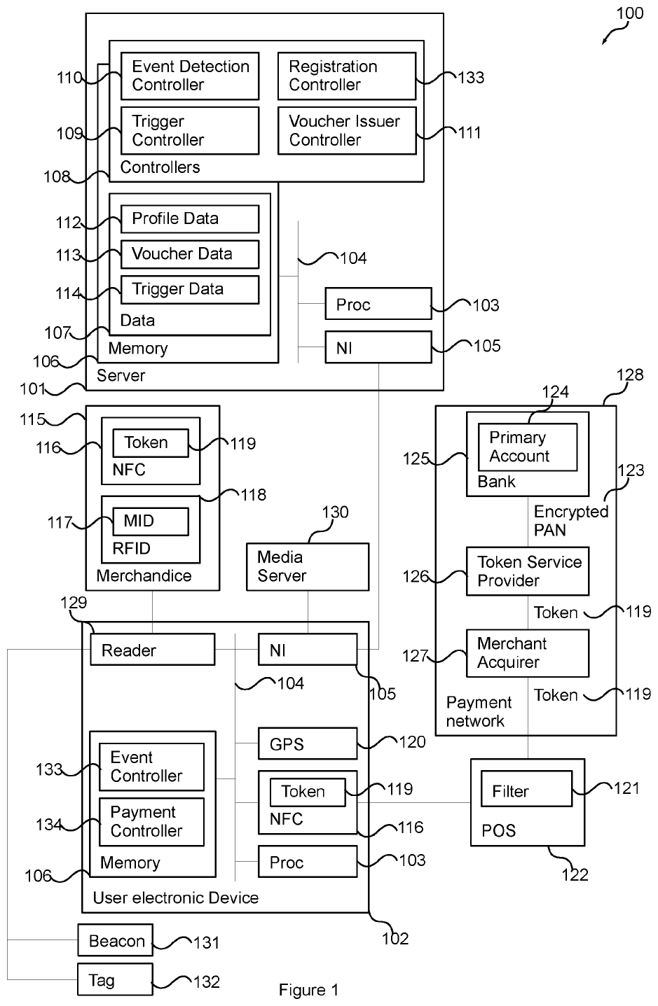

FIG. 2 shows machine learning of the system in accordance with an embodiment.

### DESCRIPTION OF EMBODIMENTS

A system 100 dynamically generates electronic payment vouchers when detecting various types of user interactions of user electronic devices 102 and their associated merchandise 115 which may be used for contactless payment using conventional POS terminals 122.

The system 100 comprises a server 101 in operable communication with a plurality of user electronic devices 102 across a wide area network, such as the Internet.

Each of the server 101 and the user electronic device 102 comprises a processor 103 for processing digital data. In operable communication with the processor 103 across a system bus 104 is a memory device 106 configured for storing digital data including computer program code instructions. In use, the processor 103 fetches these computer program code instructions and associated data 106 from the memory device 106 for interpretation and execution of the functionality described herein.

The computer program code instructions may be logically divided into various controllers 108.

The server 101 and the user electronic device 102 comprise network interfaces 105 for sending and receiving data across the wide area network.

The user electronic device 102 may comprise a receiver/reader 129 for receiving transmissions from a wireless beacon 131 and/or reading data from an RFID tag 132.

The system 100 further comprises merchandise 115 comprising an embedded device thereon. The embedded device may comprise an RFID tag 118 which may encode merchandise ID 117. The embedded device may further comprise an NFC card emulator 116. The NFC card emulator 116 may encode a token 119 therein for processing payment.

A user, having an associated user electronic device 102, such as a smartphone device or the like may purchase merchandise 115, such as a sporting team jersey. The merchandise 115 comprising the embedded device sewn thereon.

The merchandise 115 may comprise a QR™ code which, when scanned by a camera of the user electronic device 102, causes the electronic device 102 to download a software application which is installed and executed by the processor 103 thereof for implementing the functionality herein. The software application may comprise an event controller 113 and a payment controller 134.

The user may use the reader 129 of the user electronic device 102 to scan the embedded device of the merchandise 115. In one embodiment, the reader reads the merchandise ID 117 from the RFID tag 118. The merchandise ID 117 may uniquely specify an item of merchandise or alternatively specify a type of merchandise.

The user electronic device 102 may transmit the merchandise ID 117 to the server 101 wherein the registration controller 133 associates the user's user profile data 112 with the merchandise ID 117.

In this way, the user may associate the various items of merchandise 115 with the user's user profile data 112.

The server controllers 108 may comprise an event detection controller 110 configured for detecting various user interactions. The various types of user interactions events may be specified by trigger data 114.

For example, the trigger data 114 may specify an event being the association of the merchandise 115 with user profile data 112.

Furthermore, the trigger data 114 may specify an event being the proximity of the user electronic device 102 within range of a wireless beacon 131. For example, the wireless beacon 131 may be a Bluetooth Low Energy (BLE) beacon wherein the user electronic device 102 uses the reader 129 to determine the received signal strength of transmissions thereof to determine when the user electronic device 102 is within proximity of the beacon 131.

The wireless beacon 131 may, for example, be located at a retailer, fast food outlet or the like and be used to determine when the user electronic device 102 is within proximity thereof.

Furthermore, the trigger data 114 may specify an event being the tapping of the reader 129 against a tag 132, such as an RFID. For example, the tag 132 may be provided at a sporting stadium entrance wherein an event is generated when the user taps the electronic device 102 against the tag 132 when entering the stadium.

The trigger data 114 may specify user interactions with other users of a social media servers 131. For example, the event controller 133 may detect the sending of messages, invites and the like to friends of a social media network stored by the media server 131.

Other types of events may be specified by the trigger data 114.

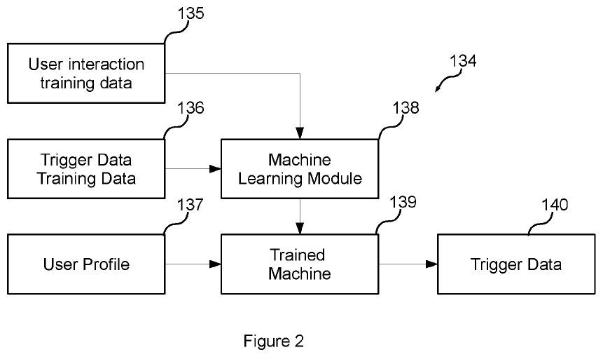

In embodiments, the controllers 108 may comprise a trigger controller 109 which dynamically generates triggers or trigger data, including in accordance with machine learning as described in further detail below with reference to FIG. 2.

Upon the event detection controller 110 detecting a user interaction event of the user electronic device 102 specified by the trigger data 114, a payment voucher issue controller 111 is configured for generating a payment voucher according to the type of user interaction event.

Furthermore, a monetary payment amount is associated with the generated payment voucher.

For example, a payment voucher may be issued to the user to the value of $10 for purchasing further merchandise when the user associates the merchandise 115 with the user's user profile in the manner described above.

By way of further example, an electronic payment voucher to the value of $12 may be issued to a user when entering a stadium (wherein the user taps the user electronic device 102 against the tag 132) which may be redeemed at a particular fast food outlet within the stadium.

By way of yet further example, a payment voucher to the value of $8 may be issued to a user when the user is within proximity of a retailer.

The voucher issue controller 111 generates payment voucher data which is written to the NFC card emulator 116 of the merchandise 115 or the user electronic device 102 to allow the user to make contactless payments using the merchandise 115 or the user electronic device 102 respectively.

Specifically, the user taps the NFC card emulator 116 against an NFC enabled POS terminal 122 which communicates with a payment network 128 for redeeming a payment up to the value of the voucher payment amount against a primary account 124 held at a bank 125.

In one embodiment, the payment voucher data comprises a tokenisation of a primary account number of the primary account 124 which is received from a token service provider 126.

As such, during payment, the POS terminal 122 reads a token 119 from the NFC card emulator 116.

The POS terminal 122 may comprise a filter 121 which detects the token 119 to be resolved.

The POS terminal 122 may pass the token 119 to a merchant acquirer 127 which passes the token 119 to the token service provider 126. The token service provider 126 may resolve the token 119 into an encrypted primary account number 123 which is transmitted to the bank 125 for decryption for processing payment against the primary account 124.

In embodiments, a single primary account 124 is used by the system 100 and wherein the system 100 checks the payment amount of purchase transactions against the voucher payment amount of the issued voucher.

For example, the voucher issue controller 111 may generate an electronic voucher to the value of $10 wherein the payment voucher data identifies the primary account number of the primary account 124 (such as by way of tokenisation) and the payment voucher amount.

As such, when subsequently processing a payment request, the payment network 128 may be configured for checking a payment request amount against the voucher amount and only processing payment if the payment request amount is the same or less than the voucher amount.

In one embodiment, the token service provider 126 may receive the token 119 and a payment request amount from the merchant acquirer 127 and communicate with the server 106 to determine if the payment request amount is the same or less than the voucher amount. If the payment request amount exceeds the voucher amount, the token service provider 126 may reject the token resolution request from the merchant acquirer 127.

In alternative embodiments, the server 101 may communicate with the bank 125 to generate a one-time use virtual primary account associated with each issued voucher. As such, in accordance with this embodiment, the payment voucher data comprises the primary account number of the virtual primary account or a tokenisation thereof.

In embodiments, the payment voucher data may be encoded by the server 101 prior transmission thereof to the user electronic device 102. As such, in accordance with this embodiment, the NFC card emulator comprises encrypted payment voucher data which may comprise a primary account number or a tokenisation thereof.

When initiating a payment, the payment controller 134 of the user electronic device 102 may firstly transmit the encrypted payment voucher data to the server 101 for decryption wherein decrypted payment voucher data received back from the server 101 is transmitted by the payment controller 134 to the POS terminal 122.

In embodiments, various voucher payment restrictions may be set against issued vouchers.

As such, in accordance with this embodiment, when decrypting the payment voucher data, the payment voucher data may be decrypted further in accordance with provided voucher payment restriction type data.

For example, vouchers may be issued which may be only redeemed at a particular merchant or for particular merchandise. As such, in use, a merchant ID or merchandise ID may be transmitted to the server 101 which can only decrypt the encrypted payment voucher data for a particular merchant ID or merchandise ID.

In embodiments, the system 100 may be configured for validating a payment request against the voucher payment restrictions prior processing payment.

For example, utilising the aforedescribed example of wherein a voucher may be issued for the purchase of further merchandise, and by way of further specific example wherein, when the user purchases a jersey of a sporting team and when associating the jersey with the user electronic device 102, the user electronic device 102 may notify the user that the user is eligible to receive $20 off an associated scarf.

As such, when generating the payment voucher data for the $20 amount, the payment voucher data may comprise a merchandise type restriction limiting the merchandise able to be purchased to scarfs.

As such, when processing payment, the payment controller 134 of the user electronic device 102 or the payment network 128 may receive a merchandise ID 117 from the POS terminal and reject the payment request against the issued voucher if the merchandise ID 117 is for an incorrect merchandise ID.

By way of further example, the voucher data may comprise a merchant restriction wherein, utilising the aforedescribed example wherein a user entering a turnstile taps the user electronic device 102 against a tag 132, and receives a voucher to the value of $8 which may be used at a particular merchant at the stadium, when processing payment, the payment controller 134 of the user electronic device 102 of the payment network 128 may receive a merchant ID from the POS terminal 122 and reject the payment request if the merchant ID is incorrect.

By way of further example, the voucher data may comprise a geo-fence restriction wherein, a voucher may be used in a particular location, such as a sporting stadium, when processing payment, the payment controller 134 may determine a location of the user electronic device 102 utilising the GPS receiver 120 thereof and reject a payment request if the location of the user electronic device 102 falls outside a geo-fence specified by the payment voucher data.

Similarly, the voucher data may be used within proximity of a wireless beacon 131 wherein the payment controller 134 may reject the payment for the user electronic device 102 when the electronic device 102 is out of range or too far away from a wireless beacon 131.

In embodiments, the voucher issue controller 122 may be configured for generating payment vouchers for a plurality of users of associated user electronic devices 102 associated by a social graph of the social media server 130.

In accordance with this embodiment, the user may invite friends to a particular location by sending an invite or message via the social media server 130. When receiving an invite or message, each user of each user electronic device 102 may be prompted to download and install the aforedescribed software application for implementing the payment functionality described herein.

The server 101 may the monitor the locations of the user electronic devices 102, either using GPS receivers 120 thereof or using the readers 129 thereof to detect proximity to a wireless beacon 131.

When detecting that all of the user electronic devices 102 are within a particular location, the voucher issue controller 111 may generate payment vouchers for each user electronic device 102.

In this way, users may congregate at a particular location to receive payment vouchers issued by the voucher issue controller 111.

In embodiments, and as alluded to above, the trigger controller 109 may dynamically configure triggers or trigger data to maximise user interactions therewith.

Specifically, FIG. 2 shows machine learning 134 comprising a machine learning module 138 which optimises a trained machine 139. The trained machine 139 may comprise an artificial neural network and, in this regard, the machine learning module 138 may optimise the weightings of the various nodes thereof.

The machine learning module 138 may train using user interaction training data 135 and trigger data training data 136. The training data 135, 136 indicates historical user interactions with various types of triggers.

As such, the machine learning module 138 is configured to optimise the trained machine 139 such that, for a given user profile 137, the trained machine 139 is configured for generating trigger data 140 that optimises user interaction therewith.

For example, the machine learning 134 may identify that female users are more likely to interact with a trigger offering a voucher for the purchase of further merchandise when associating merchandise with their user profiles. By way of further example, the machine learning 134 may identify that male users are more likely to redeem vouchers for a particular type of merchant issued when tapping the user electronic device 102 against a tag 132 when entering a sporting stadium.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A system comprising:
a server;
a user electronic device in operable communication with the server across a wide area network, the user electronic device associated with a user profile;
merchandise comprising an embedded device comprising an NFC card emulator, wherein the server comprises:
a registration controller configured to receive merchandise ID data scanned from the embedded device by the user electronic device to associate the merchandise with the user profile;
an event detection controller configured to detect a user interaction event of the user electronic device specified by trigger data;
a payment voucher issuer controller configured for:
generating an electronic payment voucher according to a type of the user interaction event and a payment amount associated with the payment voucher; and
writing payment voucher data to at least one of the NFC card emulator of the merchandise and the user electronic device;
a POS terminal configured to read the payment voucher data from at least one of the NFC card emulator of the embedded device of the merchandise and the user electronic device; and
a payment network configured for determining a primary account number from the payment voucher data and electronically processing payment up to the value of the payment amount.

2. A system as claimed in claim 1, wherein the embedded device comprises an RFID tag comprising the merchandise ID data.

3. A system as claimed in claim 1, wherein the payment voucher data comprises a tokenisation of the primary account number received from a token service provider and wherein the payment network is configured for obtaining the primary account number from the token service provider using the tokenisation.

4. A system as claimed in claim 1, wherein generating a payment voucher comprises generating a one-time virtual primary account according to the payment amount and generating the primary account number therefor.

5. A system as claimed in claim 1, wherein the payment voucher issuer controller is configured for:
encrypting the payment voucher data prior writing the payment voucher data to the NFC card emulator;
prior the POS terminal reading the payment voucher data, receiving encrypted payment voucher data from the user electronic device;
decrypting the encrypted payment voucher data; and
transmitting decrypted payment voucher data to the user electronic device.

6. A system as claimed in claim 5, wherein the payment voucher issue controller is configured for generating the payment voucher in accordance with a voucher payment restriction and wherein the payment voucher issuer controller is configured for decrypting the encrypted payment voucher data in accordance with voucher payment restriction type data.

7. A system as claimed in claim 6, wherein the voucher payment restriction type data comprises at least one of merchant ID and merchandise ID.

8. A system as claimed in claim 7, wherein the voucher payment restriction type data is obtained from the POS terminal.

9. A system as claimed in claim 1, wherein the payment voucher issue controller is configured for associating a voucher payment restriction with the payment voucher and, wherein, in use, the system is configured for processing payment depending on the voucher payment restriction.

10. A system as claimed in claim 9, wherein the voucher payment restriction comprises a merchant ID restriction and wherein, in use, the system is configured for receiving a merchant ID from the POS terminal.

11. A system as claimed in claim 9, wherein the voucher payment restriction comprises a merchandise ID restriction specifying a type of merchandise and wherein, in use, the system is configured for receiving a merchandise ID from the POS terminal.

12. A system as claimed in claim 9, wherein the voucher payment restriction comprises a location limitation and wherein, in use, the system is configured for receiving a location from the user electronic device.

13. A system as claimed in claim 12, wherein the system is configured for receiving the location from a GPS receiver of the user electronic device.

14. A system as claimed in claim 13, wherein the system is configured for receiving a location from a wireless beacon receiver of the electronic device.

15. A system as claimed in claim 1, wherein the user interaction event comprises a merchandise association event wherein the user associates the merchandise with the user profile.

16. A system as claimed in claim 1, wherein the user electronic device comprises a receiver and wherein the user interaction event comprises a proximity event when the receiver detects proximity with a wireless beacon.

17. A system as claimed in claim 1, wherein the user electronic device comprises a reader and wherein the user interaction event comprises a tap event when reader reads a specified ID of an RFID tag.

18. A system as claimed in claim 1, wherein the payment voucher issuer controller is configured for monitoring the locations of a plurality of user electronic devices and generating electronic payment vouchers for each user electronic device when the plurality of user electronic devices are detected congregating at a specified location.

19. A system as claimed in claim 18, wherein the system is configured for grouping the plurality of user electronic devices by monitoring communications with a social media server.

20. A system as claimed in claim 1, wherein the system further comprises a machine learning comprising a machine learning module configured for optimising a trained machine using user interaction and trigger training data such that the trained machine is configured to generate trigger data for a given user profile which optimises user interaction of the given user profile therewith.
